(19) United States
(12) Patent Application Publication
(10) Pub. No.: US 2024/0064528 A1
(43) Pub. Date: Feb. 22, 2024

(54) METHOD AND APPARATUS FOR REPORTING CHANNEL STATE INFORMATION

(71) Applicant: Lenovo (Beijing) Limited, Beijing (CN)

(72) Inventors: Hongmei Liu, Beijing (CN); Zhi Yan, Beijing (CN); Yuantao Zhang, Beijing (CN); Lianhai Wu, Beijing (CN); Haiming Wang, Beijing (CN)

(73) Assignee: Lenovo (Beijing) Limited, Beijing (CN)

(21) Appl. No.: 18/267,264

(22) PCT Filed: Dec. 15, 2020
(86) PCT No.: PCT/CN2020/136565

§ 371 Date: Jun. 14, 2023

(51) Int. Cl. H04W 16/28; H04B 7/06

(52) U.S. Cl. CPC H04W 16/28; H04B 7/0626

(57) ABSTRACT

Embodiments of the present application relates to a method and an apparatus for reporting channel state information. An exemplary method includes: receiving a first RS on a first link with a first spatial domain receive filter or trans-receiving a first RS on a first link with mitting the first RS on the first link with a first spatial domain transmit filter; receiving a set of second RSs on a second link with a second spatial domain receive filter or transmitting the set of second RSs on the second link with a second spatial domain transmit filter; and transmitting a CSI report, wherein the CSI report includes: at least one of an index of the first RS and a PMI associated with the first RS; and a set of CSI at least based on the set of second RSs.

### TECHNICAL FIELD

Embodiments of the present application relate to wireless communication technologies, especially to a method and apparatus for reporting channel state information (CSI).

### BACKGROUND OF THE INVENTION

In R17 integrated access and backhaul (IAB) Work Item Description (WID), space division multiplexing (SDM) between an IAB node's parent link and child link is supported. The IAB node may transmit or receive reference signal (RS) on the parent link and child link with the same or different spatial domain filters simultaneously.

Therefore, it is necessary for a parent node of the IAB node to take the CSI of the child link between the IAB node and its child node into consideration besides the CSI of the parent link between the IAB node and its parent node, so as to coordinate the resource allocation for the parent link and the child link.

### SUMMARY

An embodiment of the subject application provides a method, including: receiving a first reference signal (RS) on a first link with a first spatial domain receive filter or transmitting the first RS on the first link with a first spatial domain transmit filter; receiving a set of second RSs on a second link with a second spatial domain receive filter or transmitting the set of second RSs on the second link with a second spatial domain transmit filter; and transmitting a channel state information (CSI) report, wherein the CSI report includes: at least one of an index of the first RS and a precoding matrix indicator (PMI) based on the first RS; and a set of CSI at least based on the set of second RSs.

In an embodiment, the first spatial domain receive filter has a same configuration with the second spatial domain receive filter, the first spatial domain transmit filter has a same configuration with the second spatial domain transmit filter, or the first RS associated with the first spatial domain filter and the second RS associated with the second spatial domain filter are transmitted or received simultaneously.

In an embodiment, the method further includes receiving a radio resource control (RRC) signaling or a media access control (MAC) control element (CE) signaling indicating whether each of the set of CSI is a CSI based on both a first CSI on the first link and a second CSI on the second link, or is a CSI based on only the second CSI on the second link.

In an embodiment, wherein the CSI based on the first CSI and the second CSI is an average of the first CSI and the second CSI with a same weighting factor or with different weighting factors for the first CSI and the second CSI.

In an embodiment, the method further includes receiving a RRC signaling or MAC CE signaling indicating whether a group based beam reporting is enabled.

In an embodiment, in the case that the CSI report includes the index of the first RS, the first RS is a CSI-RS or a synchronization signal and physical broadcast channel (PBCH) block (SSB), or a sounding reference signal (SRS), each of the set of second RSs is a SRS, or CSI-RS, or SSB, and each of the set of CSI is one of reference signal received power (RSRP), reference signal received quality (RSRQ), a signal to interference plus noise ratio (SINR), a value quantifying the RSRP, a value quantifying the SINR and a value quantifying the RSRQ.

In an embodiment, each of the set of CSI is a measured value or is a reserved value.

In an embodiment, in the case that the set of second RSs are more than one second RS, the set of CSI only includes a largest CSI among all CSI based on respective one of the set of second RSs.

In an embodiment, the CSI report further includes at least one index of at least one second RS in the set of second RSs.

In an embodiment, each of the at least one index associated with the at least one second RS is a Quasi-Co-Location (QCL) type D RS of the second RS or the second RS.

In an embodiment, in the case that the set of second RSs includes more than one second RSs, the set of CSI only includes an index associated with a second RS with a largest CSI among all CSI based on respective one of the set of second RSs.

In an embodiment, the index associated with the second RS is reported together with a corresponding CSI value.

In an embodiment, the method further includes receiving a RRC signaling or MAC CE signaling indicating a maximum number of CSI in the set of CSI.

In an embodiment, each CSI value of the set of CSI is an absolute value; or except for a first CSI value being an absolute value, each other CSI value of the set of CSI is a differential value relative to the first CSI value.

In an embodiment, the method further includes receiving a third RS on a third link with a third spatial domain receive filter or transmitting the third RS on the third link with a third spatial domain transmit filter; receiving a set of fourth RSs on a fourth link with a fourth spatial domain receive filter or transmitting the set of second RSs on the fourth link with a fourth spatial domain transmit filter; and transmitting the CSI report, wherein the CSI report further includes at least one of an index of the third RS and a PMI associated with the third RS, and another set of CSI at least based on the set of fourth RS.

In an embodiment, the third spatial domain filter has a same configuration with the fourth spatial domain filter, or the third RS associated with the third spatial domain filter and the fourth RS associated with the fourth spatial domain filter are transmitted or received simultaneously.

In an embodiment, in the case of the group based beam reporting being enabled, receiving a pair of RSs including the first RS on the first link and a third RS on a third link with the first spatial domain receive filter, or transmitting the pair of RSs with the first spatial domain transmit filter, wherein the CSI report includes indexes of the pair of RSs or PMI of the pair of the RSs.

In an embodiment, each of the set of CSI includes one of the following: a PMI based on a second RS of the second link, and at least one of rank indicator (RI) and channel quality indicator (CQI) based on second RS of the second link; at least one of RI and CQI based on the second RS of the second link; and at least one of RI and CQI based on both the first RS of the first link and the second RS of the second link.

In an embodiment, the method further includes: determining the PMI for the second link based on an indicated or predefined PMI set.

In an embodiment, the CSI report is transmitted from an IAB mobile termination (MT) to an IAB distributed unit (DU) by physical uplink control channel (PUCCH) or physical uplink shared channel (PUSCH).

In an embodiment, the CSI report is transmitted from an IAB DU to another IAB DU via a F1 application protocol (F1-AP) signaling.

Another embodiment of the present application provides a method, including: receiving a first RS on a first link with a first spatial domain receive filter from a first node or transmitting the first RS on the first link with a first spatial domain transmit filter to the first node; and receiving a channel state information (CSI) report, wherein the CSI report includes: at least one of an index of the first RS and a precoding matrix indicator (PMI) associated with the first RS; and a set of CSI at least based on a set of second RSs on a second link between the first node and a second node, wherein the set of second RSs is received with a second spatial domain receive filter or transmitted with a second spatial domain transmit filter by the first node.

In an embodiment, the method further includes transmitting a RRC signaling or a MAC CE signaling indicating whether each of the set of CSI is a CSI based on both a first CSI on the first link and a second CSI on a second link, or is a CSI based on only the second CSI on the second link.

In an embodiment, the method further includes transmitting a RRC signaling or media access control (MAC) control element (CE) signaling indicating a maximum number of CSI in the set of CSI.

In an embodiment, the method further includes receiving a third RS on a third link with a third spatial domain receive filter from the first node or transmitting the third RS on the third link with a third spatial domain transmit filter to the first node; and receiving the CSI report, wherein the CSI report further includes at least one of an index of the third RS and a PMI associated with the third RS, and another set of CSI at least based on a set of fourth RSs, wherein the set of fourth RSs is received with a fourth spatial domain receive filter or transmitted with a fourth spatial domain transmit filter of the fourth spatial domain filter on a fourth link between the first node and the second node.

In an embodiment, in the case of the group based beam reporting being enabled, receiving a pair of RSs including the first RS on the first link and a third RS on a third link with the first spatial domain receive filter, or transmitting the pair of RSs with the first spatial domain or transmit filter, and the CSI report includes indexes of the pair of RSs or PMI of the pair of the RSs.

Yet another embodiment of the subject application provides an apparatus, including: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement a method according to an embodiment of the present application.

### BRIEF DESCRIPTION OF THE DRAWINGS

FIG. 1 illustrates an exemplary IAB system according to some embodiments of the present application.

FIG. 2A illustrates a flow chart of a method for transmitting or receiving channel state information according to some embodiments of the present application.

FIG. 2B illustrates a flow chart of a method for transmitting or receiving channel state information according to some other embodiments of the present application.

FIG. 3 illustrates an exemplary SDM transmission between the parent link and the child link according to some embodiments of the present application.

FIG. 4 illustrates another exemplary SDM transmission between multiple parent links and the child link according to some embodiments of the present application.

FIGS. 5A-5C illustrate exemplary IAB simultaneous transmission in the IAB node according to some embodiments of the present application.

FIG. 6 illustrates an exemplary block diagram of an apparatus 600 according to an embodiment of the present application.

### DETAILED DESCRIPTION

The detailed description of the appended drawings is intended as a description of the currently preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP long term evolution (LTE) Release 8 and so on. Persons skilled in the art know very well that, with the development of network architecture and new service scenarios, the embodiments in the present application are also applicable to similar technical problems; and moreover, the terminologies recited in the present application may change, which should not affect the principle of the present application.

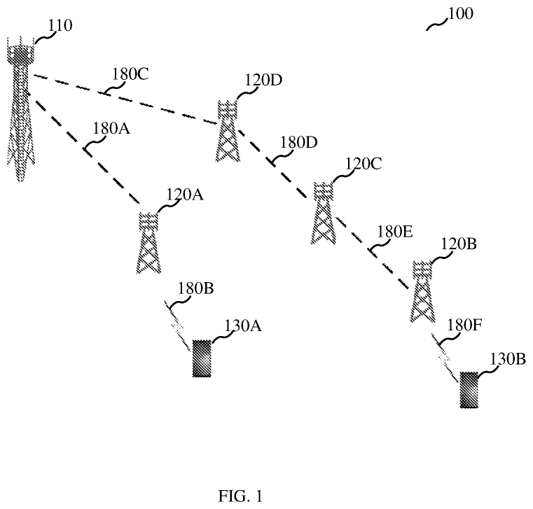

FIG. 1A illustrates an exemplary IAB system 100 according to some embodiments of the present application.

Referring to FIG. 1A, the IAB system 100 can include an IAB donor node (e.g., donor node 110), some IAB nodes (e.g., IAB node 120A, IAB node 120B, IAB node 120C, and IAB node 120D), and some UEs (e.g., UE 130A and UE 130B). Although merely, for simplicity, one donor node is illustrated in FIG. 1A, it is contemplated that IAB system 100 may include more donor node(s) in some other embodiments of the present application. Similarly, although merely four IAB nodes are illustrated in FIG. 1A for simplicity, it is contemplated that IAB system 100 may include more or fewer IAB nodes in some other embodiments of the present application. Although merely two UEs are illustrated in FIG. 1A for simplicity, it is contemplated that IAB system 100 may include more or fewer UEs in some other embodiments of the present application.

IAB node 120A is directly connected to donor node 110. IAB node 120D is directly connected to donor node 110. In this example, donor node 110 is a parent node of IAB node 120A, and also a parent node of IAB node 120D. IAB nodes 120A and 120D are child nodes of donor node 110. Link 180A between donor node 110 and IAB node 120A is a parent link of IAB node 120A. Link 180B between IAB node 120A and IAB node 130A is a child link of IAB node 120A. Link 180C between donor node 110 and IAB node 120D is a parent link of IAB node 120D. IAB node 120A can be connected to donor node(s) other than donor node 110 in accordance with some other embodiments of the present application. IAB node 120D can be connected to donor node(s) other than donor node 110 in accordance with some other embodiments of the present application.

IAB node 120C can reach donor node 110 by hopping through IAB node 120D. IAB node 120D is a parent node of IAB node 120C, and IAB node 120C is a child node of IAB node 120D. Link 180D between IAB node 120D and IAB node 120C is a child link of IAB node 120D, and also a parent link of IAB node 120C.

IAB node 120B can reach donor node 110 by hopping through IAB node 120C and IAB node 120D. IAB node 120C and IAB node 120D are upstream nodes of IAB node 120B, and IAB node 120C is a parent node of IAB node 120B. In other words, IAB node 120B is a child node of IAB node 120C. IAB node 120B and IAB node 120C are downstream nodes of IAB node 120D. Link 180E between IAB node 120C and IAB node 120B is a child link of IAB node 120C, and also a parent link of IAB node 120B.

UE 130A is directly connected to IAB node 120A via link 180B, and UE 130B is directly connected to IAB node 120B via link 180F In other words, UE 130A and UE 130B are served by IAB node 120A and IAB node 120B, respectively. In some other embodiments of the present application, UE 130A and UE 130B may also be referred to as child nodes of IAB node 120A and IAB node 120B, respectively. Link 180B is a child link of IAB node 120A. Link 180F is a child link of IAB node 120B.

Each of IAB node 120A, IAB node 120B, IAB node 120C, and IAB node 120D may be directly connected to one or more UEs in accordance with some other embodiments of the present application.

Each of IAB node 120A, IAB node 120B, IAB node 120C, and IAB node 120D may be directly connected to one or more IAB nodes in accordance with some other embodiments of the present application.

In addition, according to R17 IAB WID, the SDM between an IAB node's parent link and child link will be supported in R17. For example, for the parent link 180D of the IAB node 120C and the child link 180E of the IAB node 120C, the SDM can be implemented by allocating suitable beam (also be represented by spatial relation information, spatial domain transmit filter, spatial domain receive filter or QCL RS) and/or PMI for the parent link 180D and child link 180E. The selected beam and/or PMI in the parent link has impact on the scheduling on the child link. Thus, it is necessary to report the channel status of the child link of an IAB node with respect to a specific beam or PMI in the parent link of the IAB node, so that the parent node of the IAB node can coordinate the beam and/or PMI allocation for the parent link and child link.

Given that, embodiments of the present application at least provide a technical solution for reporting channel state information in an IAB system.

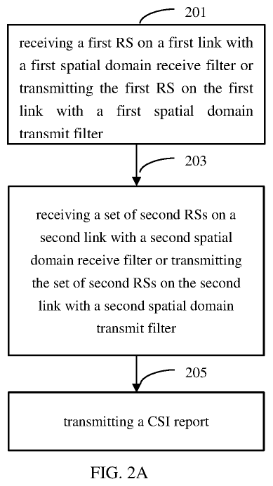

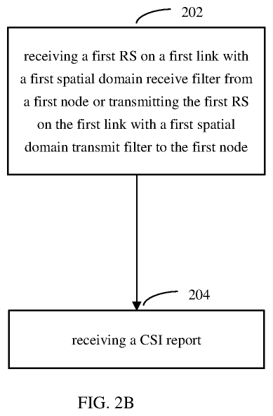

For example, FIG. 2A depicts a flow chart of a method for reporting channel state information according to some embodiments of the present application, which can be implemented on an IAB node for reporting the CSI report, e.g., IAB node 120B, or IAB node 120C, or IAB node 120D etc. In some embodiments of the present of the present application, the CSI report is transmitted from an IAB mobile termination (MT) to an IAB distributed unit (DU), e.g., from the MT of the IAB node 120B to the DU of another IAB node 120C by PUCCH or PUSCH. In some other embodiments of the present of the present application, the CSI report is transmitted from an IAB node to another IAB node, e.g., from the DU of the IAB node 120C to the DU of the IAB node 120D via a F1 application protocol (F1-AP) signaling.

For an IAB node, e.g., IAB node 120C in a SDM scenario, the parent link and the child link are spatial multiplexed by different beams. A beam is associated with a spatial domain transmit filter from the transmitter side and a spatial domain receive filter from the receiver side. Different beams can have different spatial domain transmit filter or different spatial domain receive filter. These different beams are associated with different QCL RSs, e.g. CSI-RS, SSB, SRS. For example, the DL data/control/RS transmitted on parent link and the UL data/control/RS transmitted child link are separated by different spatial domain transmit filters or alternatively, the UL data/control/RS transmitted on parent link and the DL data/control/RS transmitted child link are separated by different spatial domain receive filters. In step 201, the IAB node, e.g., the IAB node 120C may receive a first RS on a first link, e.g., a parent link of the IAB node with a first spatial domain receive filter or transmit the first RS on the first link with the first spatial domain transmit filter. The first RS is a Quasi-Co-Location (QCL) RS, which may be a CSI RS, or a SSB or a SRS. A spatial domain filter may be configured to receive data, and in this case, the spatial domain filter is a spatial domain receive filter, or a spatial domain filter; and when a spatial domain filter is configured to transmit data, the spatial domain filter is a spatial domain transmit filter, or a spatial domain

In step 203, the IAB node, e.g., the IAB node 120C may also receive a set of second RSs on a second link, e.g., a child link of the IAB node with a second spatial domain receive filter or transmit the set of second RSs on the second link with the second spatial domain transmit filter.

In an embodiment, the first spatial domain filter has the same configuration with the second spatial domain filter. The first spatial domain filter can be a spatial domain transmit filter or a spatial domain receive filter. The second spatial domain filter can also be a spatial domain transmit filter or a spatial domain receive filter.

In the case that the first spatial domain filter is a transmit filter and the second spatial domain filter is also a transmit filter, the same configuration for the first and the second spatial domain filter means that the weighting vectors of antenna elements of the transmit antenna array associated with the first spatial domain transmit filter is the same as the weighting factors of antenna elements of the transmit antenna array associated with the second spatial transmit filter.

In the case that the first spatial domain filter is a transmit filter and the second spatial domain filter is a receive filter, the same configuration for the first and the second spatial domain filter means that the weighting vectors of antenna elements of the transmit antenna array associated with the first spatial domain transmit filter is the same as the weighting factors of antenna elements of the receive antenna array associated with the second spatial receive filter.

In the case that the first spatial domain filter is a receive filter and the second spatial domain filter is a transmit filter, same configuration for the first and the second spatial domain filter means that the weighting factors of antenna elements of the receive antenna array associated with the first spatial domain receive filter is the same as the weighting vectors of antenna elements of the transmit antenna array associated with the second spatial transmit filter.

In the case that the first spatial domain filter is a receive filter and the second spatial domain filter is a receive filter, same configuration for the first and the second spatial domain filter means that the weighting vectors of antenna elements of the receive antenna array associated with the first spatial domain receive filter is the same as that of antenna elements of the receive antenna array associated with the second spatial receive filter.

In another embodiment, the first RS associated with the first spatial domain filter and the second RS associated with the second spatial domain filter are transmitted or received simultaneously. If the first RS is associated with a first spatial domain transmit filter, and the second RS is associated with a second transmit filter, the first RS and the second RS can be transmitted simultaneously. If the first RS is associated with a first spatial domain transmit filter, and the second RS is associated with a second receive filter, the operation on transmitting the first RS and receiving the second RS can be performed simultaneously. If the first RS is associated with a first spatial domain receive filter, and the second RS is associated with a second transmit filter, the operation on receiving the first RS and transmitting the second RS can be performed simultaneously. If the first RS is associated with a first spatial domain receive filter, and the second RS is associated with a second receive filter, the first RS and the second RS can be received simultaneously. In step 205, the IAB node transmits a CSI report, e.g. to its parent node. The CSI report may include: at least one of an index of the first RS and a PMI associated with the first RS, and a set of CSI at least based on the set of second RSs. Accordingly, the parent node of the IAB node can obtain the channel state of the child link of the IAB node.

In an embodiment, the IAB node may receive a RRC signaling or a MAC CE signaling. The RRC signaling or the MAC CE signaling indicates whether each CSI in the set is based on both a first CSI on the first link and a second CSI on the second link, or based on the second CSI on the second link only. In other words, the RRC signaling or the MAC CE signaling indicates whether each CSI is based on both a first CSI on the parent link and a second CSI on the child link, or based on the second CSI on the child link only.

When the CSI is based on both a first CSI on the parent link and a second CSI on the child link, the CSI may be a value determined based on the first CSI and the second CSI with a same weighting factor or with different weighting factors for the first CSI and the second CSI. For example, supposing the CSI on the parent link is CSI₁, and the CSI value on the child link is CSI₂, then the value of the CSI may be x×CSI₁+y×CSI₂, wherein x and y are weighting factors, and the values of x and y are any value that satisfy the following conditions: 0=<x<=1, 0=<y<=1, and x+y=1. When x=y=0.5, the reported CSI value is an average value of the first CSI of the parent link and the second CSI of the child link.

In another embodiment, the IAB node may receive the RRC signaling or the MAC CE signaling which indicates whether a group based beam reporting is enabled. In other words, the RRC signaling or the MAC CE signaling indicates whether the child node is enabled to be scheduled with more than one first RSs on the parent link simultaneously.

In the case that the CSI report includes the index of the first RS, the first RS may be is a CSI-RS or a SSB, or a SRS); each RS of the set of second RSs may be a SRS, or CSI-RS, or SSB; and each CSI of the set of CSI may be: RSRP, RSRQ, SINR, a value quantifying the RSRP, a value quantifying the SINR and a value quantifying the RSRQ. Persons skilled in the art should know well that the present application may use one parameter, RSRP for describing the technical solution, while the other parameters in addition to the exemplary one can also be applied in the present application.

In some embodiments of the present application, a value represented a CSI that used to quantify the channel state is a measured value or is a reserved value, e.g. 0. For example, a SRS resource on a child link and the associated QCL RS in the parent link can be received simultaneously by the same spatial domain receive filter at an IAB node, and then the CSI to be reported, e.g., RSRP or SINR is the value measured by the IAB node based on the SRS. Otherwise, the CSI to be reported is 0

In the case that the set of second RSs includes more than one second RS, the set of CSI only includes the largest CSI among all CSI based on respective RS of the set of second RSs. For example, the set of second RSs include three second RSs: RS₂₁, RS₂₂, and RS₂₃, and the CSI values are CSI₂₁, CSI₂₂, and CSI₂₃ respectively. If the largest CSI is CSI₂₁, the set of CSI will include only CSI₂₁.

The CSI report may further include at least one index associated the second RS in the set of second RSs. For instance, the CSI report includes at least one index of the three second RSs, RS₂₁, RS₂₂, RS₂₃. In an embodiment, each of the at least one index associated with the at least one second RS is a QCL type D RS or spatial relation information configuration of the second RS. E.g. the second RS is SRS, and the SRS with largest receives RSRP at an IAB node is RS₂₁, and spatial relation information configuration of RS₂₁ is a downlink RS CSI-RS #1, so the index of CSI RS #1 will be included as the CSI report.

When the set of second RSs includes more than one second RSs, the set of CSI may only include an index of a second RS with a largest CSI among all CSI based on respective one of the set of second RSs. For example, the set of second RSs include three second RSs, RS₂₁, RS₂₂, and RS₂₃, and the CSI values are CSI₂₁, CSI₂₂, and CSI₂₃ respectively. If the largest CSI is CSI₂₁, the set of CSI will include only the index of RS₂₁. The IAB node may also report the index of the second RS together with the corresponding CSI value, that is, the CSI report include the index of RS₂₁ and the value, CSI₂₁.

The IAB node may receive a RRC signaling or MAC CE signaling, e.g. from the parent node, which indicates a maximum number of CSI in the set of CSI. Each CSI value of the set of CSI may be an absolute value. In some other embodiments of the present application, each CSI value may be: except for the first CSI value being an absolute value, each other CSI value of the set of CSI is a differential value relative to the first CSI value. For example, there are three values, CSI₁, CSI₂, and CSI₃, and then the CSI report may include the CSI values in any of the following manners: i) CSI₁, CSI₂, and CSI₃, or ii) CSI₁, CSI₁-CSI₂, and CSI₁-CSI₃, wherein CSI₁, is the largest value among the three values.

For example, in addition to the first RS and the second RS, the IAB node may also receive a third RS on a third link, e.g., another parent link with a third spatial domain receive filter, or transmit the third RS on the third link with a third spatial domain transmit filter; and the IAB node may also receive a set of fourth RSs on a fourth link, e.g., another child link with a fourth spatial domain receive filter or transmit the set of second RSs on the fourth link with a fourth spatial domain transmit filter. Then the CSI report transmitted by the IAB node may further include at least one of an index of the third RS and a PMI associated with the third RS, and another set of CSI at least based on the set of fourth RS.

Similarly, the third spatial domain filter may have the same configuration with the fourth spatial domain filter. For example, the weighting vectors of the antenna elements of the antenna array for the third spatial domain filter are identical to those of the fourth spatial domain filter. Alternatively, the third RS associated with the third spatial domain filter and the fourth RS associated with the fourth spatial domain filter are transmitted or received simultaneously.

In an embodiment, when the group based beam reporting being enabled, the IAB node may receive or transmit a pair of RSs including the first RS on the first link and a third RS on a third link with the first spatial domain receive or transmit filter, and the CSI report includes indexes of the pair of RSs or PMIs of the pair of the RSs. In other words, the CSI report may include the index of the first RS, and the index of the third RS, or the PMI of the first RS and the PMI of the third RS. Alternatively, when the pair of RSs or PMIs has an index, then the CSI report may include the index of the pair of the first RS and the third RS, or the index of the PMI of the pair of the first and the third RS.

Alternatively, each of the set of CSI may include the following parameters: a PMI based on a second RS of the second link, and at least one of RI and CQI based on second RS of the second link; at least one of RI and CQI based on the second RS of the second link; and at least one of RI and CQI based on both the first RS of the first link and the second RS of the second link. The IAB node or its parent node may determine the PMI for the second link based on an indicated or predefined PMI set.

On the CSI report receiving side, a similar procedure can be performed. For example, FIG. 2B depicts a flow chart of a method for reporting channel state information according to some other embodiments of the present application, which can be implemented on an IAB node receiving the CSI report, e.g., IAB node 120B, or IAB node 120C, or IAB node 120D etc. In some embodiments of the present application, the CSI report is transmitted from an IAB MT and received by an IAB DU via PUCCH or PUSCH. In some other embodiments of the present of the present application, the CSI report is transmitted from an IAB DU and received by another IAB DU via a F1-AP signaling. Considering the consistency between the CSI transmitting side and receiving side, the exemplary procedure will be briefly illustrated in the receiving side.

As shown in FIG. 2B, in step 202, the IAB node, e.g., the IAB node 120C as the parent node of IAB node 120B may transmit a first RS on a first link, e.g., a parent link of the IAB node with a first spatial domain transmit filter or receive the first RS on the first link with the first spatial domain receive filter. The first RS is a QCL RS, which may be a CSI RS, or a SSB or a SRS.

In step 204, the IAB node 120C as the parent node of IAB node 120B may receive a CSI report, e.g. from its child node, e.g., the IAB node 120B. The CSI report may include: at least one of an index of the first RS and a PMI associated with the first RS, and a set of CSI at least based on the set of second RSs on a second link, e.g., the child link of the IAB node 120B. Accordingly, the parent node of the IAB node can obtain the channel state of the child link of the IAB node.

In an embodiment, the first spatial domain filter has the same configuration with the second spatial domain filter. For example, the weighting vectors of the antenna elements of the antenna array for the first spatial domain filter are identical to those of the second spatial domain filter. In another embodiment, the first RS associated with the first spatial domain filter and the second RS associated with the second spatial domain filter are transmitted or received simultaneously.

Based on the above basic solutions, more details will be illustrated in various embodiments in view of various application scenarios hereafter. Persons skilled in the art should understand that although some specific embodiments based on the basic are illustrated in view of specific scenarios, the illustrated solutions may also be applicable to some other scenarios and should not be limited to the specific scenarios.

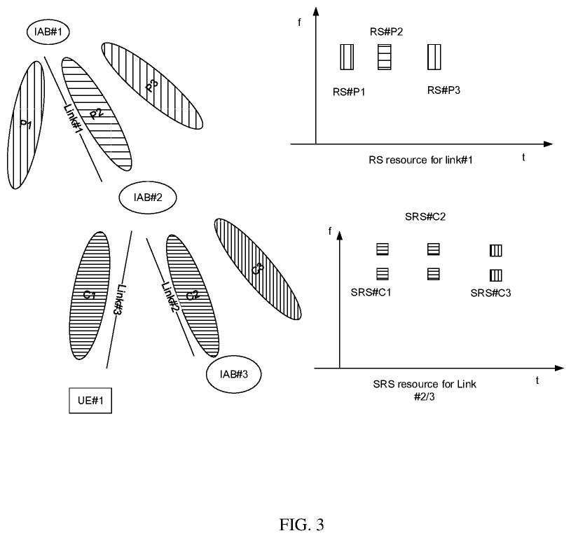

FIG. 3 illustrates an exemplary SDM transmission between the parent link and the child link according to some embodiments of the present application. In FIG. 3, IAB #1 is the parent node, and IAB #2 is the child node of IAB #1, and IAB #3 is the child node of IAB #2. For IAB #2, Link #1 is the parent link of IAB #2, and Link #2 and Link #3 are child links of IAB #2. Link #1 includes three beams, i.e., beam P1, beam P2, and beam P3. Link #2 includes two beams, i.e., beam C2 and beam C3. Link #3 includes one beam, i.e., beam C1. The RS resource in frequency domain and time domain associated with beam P1, P2, and P3 of Link #1 are represented as RS #P1, RS #P2, and RS #P3, the SRS resource in frequency domain and time domain associated with beam C1, C2, and C3 of Link #2 and Link #3 are represented as SRS #C1, SRS #C2, and SRS #C3. It should be noted that the beam may also be as associated with the spatial domain filter, which includes a spatial domain receive filter and a spatial domain transmit filter.

For IAB #2, there are different restrictions on the selected beam or PMI on its parent link and child link. In FIG. 3, beam #P2 and beam #C2 can be received simultaneously by IAB #2 with the same spatial domain receive filter, while IAB #2 cannot receive beam #P1. IAB #1 may use beam #P1 to schedule transmissions of other UEs without any impact to the transmission on Link #2 and Link #3, which is the link between IAB #2 and IAB #3. IAB #2 may use beam #C1 for Link #3, however, beam #C1 cannot be used simultaneously with beam #P2 with the same spatial domain filter, because beam #C1 and beam #P2 are associated with different spatial domain filters.

Thus, the selected beam or PMI in the parent link has impact on the scheduling on child link. For example, if the parent beam, beam #P2 is selected, then the child beam, beam #C3 may be selected, too, because they can be simultaneously transmitted or received with the same spatial domain filter. However, IAB #1 does not know the CSI associated with beam #C2, and also does not know whether IAB #2 can or cannot use beam #C2 simultaneously with beam #P2. Therefore, it is necessary for a child IAB node, i.e. IAB #2, to report the CSI of its child link with respect to a specific beam or PMI in its parent link, so that IAB #1 can coordinate the beam or PMI allocation for the parent link, i.e. link #1, and the child link, i.e. link #2 and link #3.

Some embodiments of the present application propose that IAB #2 transmits a CSI report to IAB #1. In an embodiment, IAB #1 only schedules one RS for IAB #2. The CSI report may be enabled by a RRC signaling or MAC CE signaling or predefined in specification. The contents of the CSI report may also be configured by a RRC signaling or MAC CE signaling. For example, the RRC signaling or MAC CE signaling may configure that the CSI report includes: an index of a RS on link #1 and a CSI based on a RS on link #2. The RS may be a QCL RS, for example, CSI-RS, SSB or SRS of the parent link, or the like. The CSI may be RSRP, RSRQ, SINR or a value quantifying the RSRP, RSRQ, or the SINR, or any data that may reflect the channel state of the child link.

Alternatively, the RRC signaling or MAC CE signaling may configure that the CSI report include: an index of a RS on link #1 and a CSI based on both the RS on the parent link, i.e. link #1 and the RS on the child link, i.e. link #2. In particular, the CSI may be a combined value of RSRP, RSRQ, SINR or a value quantifying the RSRP, RSRQ, or the SINR, or any data that may reflect the channel state, for both the parent link and the child link. Taking RSRP as an example, the RSRP of the parent link is represented as RSRP₁, and the RSRP of the child link is represented as RSRP₂, then the combined value may be: x×RSRP₁+y×RSRP₂, wherein x and y are weighting factors, and the values of x and y may be any value that satisfy the following conditions: 0=<x<=1, 0=<y<=1, and x+y=1. When x=y=0.5, the combined value is an average value of the RSRP of the parent link and the RSRP of the child link.

The IAB node, e.g. IAB #2 in FIG. 3, may simultaneously receive or transmit data/control/RS on the parent link or the child link. For example, in case 1: IAB #2 may receive data/control/RS on the parent link and receive data/control/RS from the child link; in case 2: IAB #2 may receive data/control/RS on the parent link and transmit data/control/RS from the child link; in case 3: IAB #2 may transmit data/control/RS on the parent link and receive data/control/RS from the child link; and in case 4: IAB #2 may transmit/control/RS data on the parent link and transmit data/control/RS from the child link. In these cases, the QCL RS is a NZP CSI-RS or a SSB or a SRS on the parent link, and the RSRP or SINR is measured based on SRS, CSI-RS or SSB received or transmitted at IAB #2 on the child link.

If the RS on the parent link is a DL RS, e.g. SSB or CSI-RS, and the RS on the child link is a UL RS, e.g. SRS, and the DL RS on parent link and UL RS on child link can be received by the same spatial domain receive filter, or can be received simultaneously by different spatial domain receive filters at IAB #2, the CSI value based on SRS on the child link is the value measured by IAB #2 on the child link, e.g. −60 dBm, otherwise, the CSI value is a reserved value, e.g. 0.

If the RS on parent link is a DL RS, e.g. SSB or CSI-RS, and the RS on the child link is also a DL RS, e.g. CSI-RS, SSB, and IAB #2 can receive DL RS on parent link and transmit DL RS on child link simultaneously, the CSI value based on CSI-RS or SSB on the child link is the value measured by IAB #2's child node (e.g. IAB #3), e.g. −70 dBm, otherwise, the CSI value is a reserved value, e.g. 0. Simultaneous reception CSI-RS/SSB on parent link and transmission CSI-RS/SSB on child link can be implemented by different RF chains with self-interference mitigation mechanism.

If the RS on parent link is a UL RS, e.g. SRS, and the RS on the child link is a DL RS, e.g. CSI-RS or SSB, and the UL RS on parent link and DL RS on child link can be transmitted by the same spatial domain transmit filter, or can be transmitted simultaneously by different spatial domain transmit filters at IAB #2, the CSI value based on CSI-RS or SSB on the child link is the value measured by IAB #2's child node (e.g. IAB #3) on the child link, e.g. −80 dBm, otherwise, the CSI value is a reserved value, e.g. 0.

If the RS on parent link is a UL RS, e.g. SRS, and the RS on the child link is also a UL RS, e.g. SRS, and IAB #2 can transmit UL RS on parent link and receive UL RS on child link simultaneously, the CSI value based on SRS on the child link is the value measured by IAB #2, e.g. −65 dBm, otherwise, the CSI value is a reserved value, e.g. 0. Simultaneous transmission of SRS on parent link and reception of SRS on child link can be implemented by different RF chains with self-interference mitigation mechanism.

In a scenario, if IAB #2 receives more than one SRS resource, for example, IAB #2 may receive the first SRS resource associated with beam C2, and the second SRS resource associated with beam C3, and beam C2 and C3 are both associated with a DL RS or a UL RS, for example, a RS associated with beam P2, then the largest RSRP or SINR measured on SRS may be selected or reported.

In a scenario, if IAB #2 transmits more than one DL RS, e.g. CSI-RS or SSB, for example, IAB #2 may receive the first CSI-RS resource associated with beam C2, and the second CSI-RS resource associated with beam C3, and beam C2 and C3 are both associated with a DL RS or a UL RS, for example, a RS associated with beam P2, then the largest RSRP or SINR measured on CSI-RS may be selected or reported.

A RRC signaling may configure the maximum number of RSRP or SINR or RSRQ values. For example, a number, ranges from 0 to the maximum number, of RSRP or SINR or RSRQ may be associated with a CRI or SSB index or SRS resource index in the parent link. Supposing there are three values, V₁, V₂, and V₃, then the report may include the values in the following manners: i) V₁, V₂, and V₃, or ii) V₁, V₁-V₂, and V₁-V₃, wherein V₁, is the largest value among the three values.

In another case, the RRC signaling may configure a number of QCL RS and RSRP or SINR or RSRQ values pair, e.g. 2. For example, for the RS associated with beam P2 in FIG. 3, IAB #2 may also receive the SRS associated with beam C2 simultaneously with the RS associated with beam P2, thus the CSI of link #2, i.e. the associated RSRP or SINR or RSRQ of link #2, is the value measured based on the SRS associated with beam C2, e.g. −75 dBm. For RS associated with beam P3 in FIG. 3, IAB #2 cannot receive any SRS simultaneously with RS associated with beam P3, therefore, the associated RSRP or SINR measured based on SRS of child link associated with beam P3 is 0. In this case, the CSI report will include CSI-RS index #P2, −75 dBm and CSI-RS index #P3, 0 will be reported. The CSI-RS resource index and the corresponding RSRP/SINR/RSRQ pair is 2 in this case.

IAB #2 may further transmit the index of the RS index (e.g. SRS resource index, CSI-RS resource index, SSB index) of the child link in the CSI report. For example, if a CSI-RS #P2 associated with beam P2 is configured to IAB #2, and SRS resource #C2 can be received simultaneously with CSI-RS #P2, and the RSRP value measured based on SRS resource #C2 is −60 dBm, the CSI report will include CSI-RS resource index P2, measured value on child link, e.g. −60 dBm and SRS resource index C2. If a UL RS (e.g. SRS #P3) associated with beam P3 is configured to IAB #2, and no SRS resource on child link can be received simultaneously when there is uplink SRS #P3 transmission on parent link, the CSI report of child link status will be SRS resource index P3, reserved value 0 and reserves child link index, e.g. −1. If a UL RS (e.g. SRS #P3) associated with beam P3 is configured to IAB #2, and no CSI-RS or SSB on child link can be transmitted simultaneously with SRS #P3 on parent link, the CSI report of child link status will be SRS resource index P3, reserved value 0 and reserves child link DL RS index, e.g. −2.

Alternatively, the index associated with the child link RS transmitted by IAB #2 in the CSI report can also be a RS with same spatial relation information of the child link's RS, or a RS which is a QCL type D RS of the child link's RS, or a RS which is the spatial relation information configuration of the child link's RS. For example, if a CSI-RS #P2 associated with beam P2 is configured to IAB #2, and SRS resource #C2 can be received simultaneously with CSI-RS #P2, and the RSRP value measured based on SRS resource #C2 is −60 dBm, if the RS index associated with the child link is a RS with same spatial relation information as SRS in child link, then the CSI report will include CSI-RS resource index P2, measured value on child link, e.g. −60 dBm and a CSI-RS resource index Cn, wherein Cn and SRS resource index C2 have the same spatial relation information, or CSI-RS resource Cn is a QCL type D RS of SRS resource #C2, or the spatial relation information configuration of SRS resource #C2 is CSI-RS resource Cn.

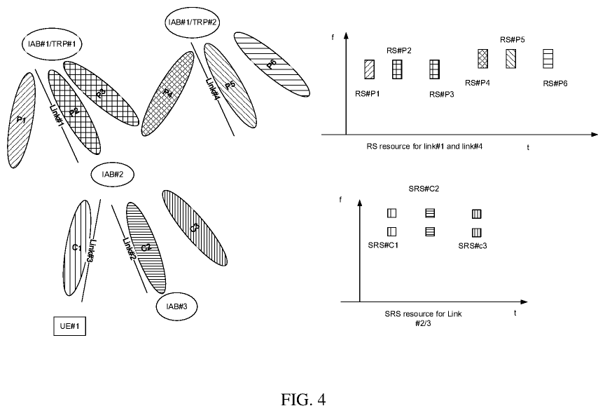

FIG. 4 illustrates another exemplary SDM transmission between multiple parent links and the child link according to some embodiments of the present application.

In an embodiment, group based beam reporting in parent link is enabled. Accordingly, a group of QCL RSs might be received or transmitted by IAB #2 simultaneously. The QCL RS can be CSI-RS, SSB or SRS. In FIG. 4, IAB #1 includes two TRPs, TRP #1 and TRP #2. The parent link, i.e., Link #1 includes three beams, i.e., beam P1, beam P2 and beam P3, and the parent link, i.e., Link #4 include three beams, i.e., beam P4, beam P5, and beam P6. The RS resource in frequency domain and time domain associated with beam P1, P2, P3, P4, P5, and P6 are represented as RS #P1, RS #P2, RS #P3, RS #P4, RS #P5, and RS #P6 respectively. The RS on parent link can be CSI-RS, SSB or SRS. The SRS resource in frequency domain and time domain resource associated with the beam C1, C2 and C3 are represented as SRS #C1, SRS #C2, and SRS #C3 respectively. Although only SRS is illustrated in FIG. 4, CSI-RS, SSB can also be associated with the child link of IAB #2.

In FIG. 4, supposing that RS #P2 and RS #P5 can be received by IAB #2 with a single spatial domain filter or can be received by IAB #2 with different spatial domain receive filters simultaneously, then the CSI report transmitted by the child node may include indexes of the pair of RSs. Alternatively, the CSI report transmitted by the child node may include both indices P2 and P5. In some other embodiments, the CSI report includes the PMI of RS #P2 and the PMI of RS #P5. Alternatively, if the pair of RSs or PMIs has an index as a pair, then the CSI report may include the index of the pair of RS #P2 and RS #P5, or the index of the PMI of the pair of RS #P2 and RS #P5.

If RS #P2 and RS #P5 are DL RS, e.g. CSI-RS or SSB, and RS on child link is UL RS, e.g. SRS, and IAB #2 can receive RS #P2, RS #P5 and SRS #C2 with a single spatial domain receive filter or multiple spatial domain receive filters simultaneously, then the CSI value may be the RSRP, RSRQ, SINR or a value quantifying the RSRP, RSRQ, or the SINR measured based on SRS #C2. If RS #P2 and RS #P5 are DL RS, e.g. CSI-RS or SSB, and RS on child link is DL RS, e.g. CSI-RS or SSB, and IAB #2 can receive RS #P2, RS #P5 and transmit CSI-RS #C2 simultaneously, then the CSI value may be the RSRP, RSRQ, SINR or a value quantifying the RSRP, RSRQ, or the SINR measured based on CSI-RS #C2. If RS #P2 and RS #P5 are UL RS, e.g. SRS, and RS on child link is UL RS, e.g. SRS, and IAB #2 can transmit RS #P2, RS #P5 and receive SRS #C2 simultaneously, then the CSI value may be the RSRP, RSRQ, SINR or a value quantifying the RSRP, RSRQ, or the SINR measured based on SRS #C2. If RS #P2 and RS #P5 are UL RS, e.g. SRS, and RS on child link is DL RS, e.g. CSI-RS or SSB, and IAB #2 can transmit RS #P2, RS #P5 and CSI-RS #C2 with a single spatial domain transmit filter or multiple spatial domain transmit filters simultaneously, then the CSI value may be the RSRP, RSRQ, SINR or a value quantifying the RSRP, RSRQ, or the SINR measured based on CSI-RS #C2.

If RS #P2 and RS #P5 are DL RS, e.g. CSI-RS or SSB, and RS on child link is UL RS, e.g. SRS, and IAB #2 can receive RS #P2, RS #P5 and SRS #C2 and SRS #C3 with a single spatial domain receive filter or multiple spatial domain receive filters simultaneously, and if the number of reported quantities of child link is 1, then the CSI value may be the largest RSRP, RSRQ, SINR or a value quantifying the RSRP, RSRQ, or the SINR measured based on SRS #C2 and SRS #C3. If RS #P2 and RS #P5 are DL RS, e.g. CSI-RS or SSB, and RS on child link is DL RS, e.g. CSI-RS or SSB, and IAB #2 can receive RS #P2, RS #P5 and transmit CSI-RS #C2 and CSI-RS #C3 simultaneously, and if the number of reported quantities of child link is 1, then the CSI value may be largest the RSRP, RSRQ, SINR or a value quantifying the RSRP, RSRQ, or the SINR measured based on CSI-RS #C2 can CSI-RS #C3.

If RS #P2 and RS #P5 are UL RS, e.g. SRS, and RS on child link is UL RS, e.g. SRS, and IAB #2 can transmit RS #P2, RS #P5 and receive SRS #C2 and SRS #C3 simultaneously, and if the number of reported quantities of child link is 1, then the CSI value may be the largest RSRP, RSRQ, SINR or a value quantifying the RSRP, RSRQ, or the SINR measured based on SRS #C2 and SRS #C3. If RS #P2 and RS #P5 are UL RS, e.g. SRS, and RS on child link is DL RS, e.g. CSI-RS or SSB, and IAB #2 can transmit RS #P2, RS #P5 and CSI-RS #C2 and CSI-RS #C3 with a single spatial domain transmit filter or multiple spatial domain transmit filters simultaneously, and if the number of reported quantities of child link is 1, then the CSI value may be the largest RSRP, RSRQ, SINR or a value quantifying the RSRP, RSRQ, or the SINR measured based on CSI-RS #C2 and CSI-RS #C3.

If RS #P2 and RS #P5 are DL RS, e.g. CSI-RS or SSB, and RS on child link is UL RS, e.g. SRS, and IAB #2 can NOT receive RS #P2, RS #P5 and SRS #C2 and SRS #C3 with a single spatial domain receive filter or multiple spatial domain receive filters simultaneously, then the CSI value may be 0.

If RS #P2 and RS #P5 are DL RS, e.g. CSI-RS or SSB, and RS on the child link is DL RS, e.g. CSI-RS or SSB, and IAB #2 can NOT receive RS #P2, RS #P5 and transmit CSI-RS #C2 and CSI-RS #C3 simultaneously, then the CSI value may be 0. If RS #P2 and RS #P5 are UL RS, e.g. SRS, and RS on child link is UL RS, e.g. SRS, and IAB #2 can NOT transmit RS #P2, RS #P5 and receive SRS #C2 and SRS #C3 simultaneously, then the CSI value may be 0. If RS #P2 and RS #P5 are UL RS, e.g. SRS, and RS on child link is DL RS, e.g. CSI-RS or SSB, and IAB #2 can NOT transmit RS #P2, RS #P5 and CSI-RS #C2 and CSI-RS #C3 with a single spatial domain transmit filter or multiple spatial domain transmit filters simultaneously, then the CSI value may be 0.

IAB #2 may also report the index associated with the RS resource which is associated with the RS pair in the CSI report. Alternatively, the RS index which is the QCL type D RS of the RS resource or have same spatial relation information of the RS resource or a RS which is the spatial relation information configuration of the RS resource can be reported.

In an embodiment, the layer-level SDM between parent link and child link is adopted, e.g. the parent link and child link are spatial multiplexed by different precoder. In other words, the parent link and the child link are associated with different precoding vector index. The CSI report may include the PMI associated with the RSs of the parent link.

Regarding the child link, the CSI report may include a PMI based on a second RS of the child link, and at least one of RI and CQI based on second RS of the child link. PMI has similar function as RS resource index of child link, e.g. SRS indicator (SRI). In an embodiment, a codebook may be indicated or predefined for PMI for child link. RI with or without CQI is a rough estimate of the child link throughput, which has a similar function as CSI value for the beam-level CSI reporting. The reported RI or CQI may be the largest achievable value among all possible scheduling decisions at the child link. For example, the specification may define a DL codebook or a UL codebook for PMI. In some other embodiments, the CSI report may include at least one of RI and CQI based on the second RS of the child link. In some yet other embodiments, the CSI report may include at least one of RI and CQI based on both the first RS of the parent link and the second RS of the child link.

RI or CQI can be associated with both the parent link and the child link. For example, the RI may indicate the achievable layer number combining the parent link layer number and child link layer number. The CQI may be the average value of the CQI for parent link and CQI for child link. Here the RI or CQI being associated means that DL signals with the reported PMI of parent link and UL signals with the reported PMI of child link can be received simultaneously at IAB #2 or IAB #2 can receive DL signals with the reported PMI of parent link and transmit DL signals with the reported PMI of child link simultaneously, or IAB #2 can transmit UL signals with the reported PMI of parent link and transmit DL signals with the reported PMI of child link simultaneously, or IAB #2 can transmit UL signals with the reported PMI of parent link and receive UL signals with the reported PMI of child link simultaneously

The CSI report which includes PMI, RI, or CQI may also be associated with at least one DL QCL RS. In this case, the parent link reporting granularity is beam level, and the child link reporting granularity is layer-level. The CSI report regarding the parent link may be a single RS with group base beam reporting disabled. Alternatively, the CSI report regarding the parent link may be a RS pair with group base beam reporting disabled.

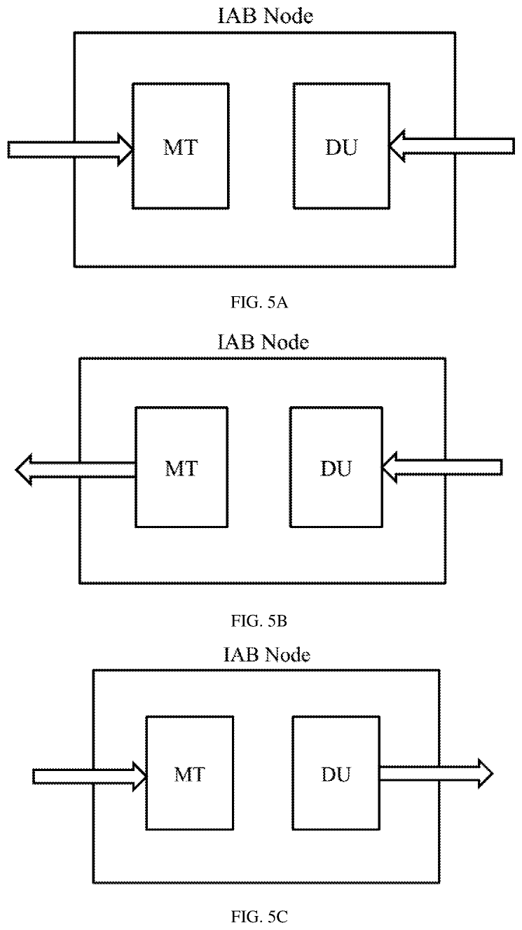

FIGS. 5A-5C illustrate exemplary IAB simultaneous transmission in an IAB node according to some embodiments of the present application.

In FIGS. 5A-5C, the IAB node may include a DU and a MT, and the DU and MT may perform simultaneous operations. Specifically, in FIG. 5A, the DU is performing reception, and the MT is performing reception. In FIG. 5B, the DU is performing reception, and the MT is performing transmission. In FIG. 5C, the DU is performing transmission, and the MT is performing reception.

In FIGS. 5A-5C, instead of DL RS in the parent link, the parent node may receive SRS in the parent link from the child node, and the indication for the SRS is SRI.

In this case, the RS index for parent link may be CSI-RS resource index, SSB index, or SRS resource index, and the RS index for child link may be SSB index, CRI, SRI, PMI with indicated or predefined codebook. When a RS on the parent link and the RS on child link can be transmitted or received simultaneously, then the CSI report may include the index of the RS on the parent link and the RS on child link. Specifically, the CSI report may include the following four cases: i) a DL RS on parent link and a DL RS on child link; ii) a DL RS on parent link and a UL RS on child link; iii) a UL RS on parent link and a DL RS on child link; and iv) a UL RS on parent link and a UL RS on child link.

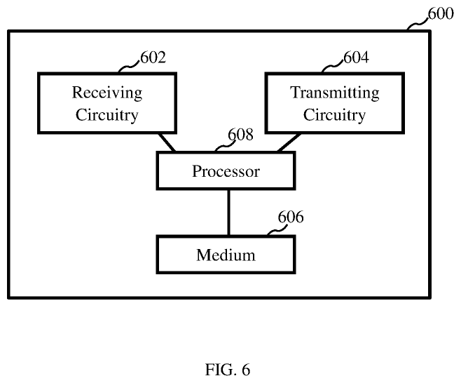

FIG. 6 illustrates an exemplary block diagram of an apparatus 600 according to an embodiment of the present application. In some embodiments of the present application, the apparatus 600 may be an IAB node or other devices having similar functionalities, which can at least perform the method illustrated in FIGS. 2A and 2B.

As shown in FIG. 6, the apparatus 600 may include at least one receiving circuitry 602, at least one transmitting circuitry 604, at least one non-transitory computer-readable medium 606, and at least one processor 608 coupled to the at least one receiving circuitry 602, the at least one transmitting circuitry 604, the at least one non-transitory computer-readable medium 606. Although FIG. 6 shows that the at least one receiving circuitry 602, the at least one transmitting circuitry 604, the at least one non-transitory computer-readable medium 606 are directly coupled with the at least one processor 608, it should be understand that all the components in apparatus 600 can be coupled to a data bus so as to be connected and communicate with each other.

Although in FIG. 6, elements such as receiving circuitry 602, transmitting circuitry 604, non-transitory computer-readable medium 606, and processor 608 are described in the singular, the plural is contemplated unless limitation to the singular is explicitly stated. In some embodiments of the present application, the at least one receiving circuitry 602 and the at least one transmitting circuitry 604 are combined into a single device, such as a transceiver. In certain embodiments of the present application, the apparatus 600 may further include an input device, a memory, and/or other components.

In some embodiments of the present application, the at least one non-transitory computer-readable medium 606 may have stored thereon computer-executable instructions which are programmed to cause the at least one processor 608 to implement the steps of the methods, for example as described in view of FIGS. 2A and 2B, with the at least one receiving circuitry 602 and the at least one transmitting circuitry 604. For example, when executed, the instructions may cause the at least one processor 608 to receive, with the at least one receiving circuitry 602, a first RS on a first link with a first spatial domain receive filter or transmitting the first RS on the first link with a first spatial domain transmit filter, and receiving a set of second RSs on a second link with a second spatial domain receive filter or transmitting the set of second RSs on the second link with a second spatial domain transmit filter. The instructions may further cause the at least one processor 608 to transmit, with the at least one transmitting circuitry 604, a CSI report.

The method of the present application can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present application.

While the present application has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present application by simply employing the elements of the independent claims. Accordingly, the embodiments of the present application as set forth herein are intended to be illustrative, not limiting. Various changes may be made without departing from the spirit and scope of the present application.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

What is claimed is:

1. An apparatus, comprising:
a memory; and
a processor coupled to the memory, the processor configured to cause the apparatus to:
receive a first reference signal (RS) on a first link with a first spatial domain receive filter or transmit the first RS on the first link with a first spatial domain transmit filter;
receive a set of second RS on a second link with a second spatial domain receive filter or transmit the set of second RS on the second link with a second spatial domain transmit filter; and
transmit a channel state information (CSI) report,
the CSI report including:
at least one of an index of the first RS or a precoding matrix indicator (PMI) based on the first RS; and
a set of CSI at least based on the set of second RS.

2. The apparatus of claim 1, wherein one or more of:
the first spatial domain receive filter has a same configuration with the second spatial domain receive filter;
the first spatial domain transmit filter has a same configuration with the second spatial domain transmit filter; or
the first RS associated with the first spatial domain filter and the second RS associated with the second spatial domain filter are one or more of transmitted or received simultaneously.

3. The apparatus of claim 1, wherein if the CSI report comprises the index of the first RS, at least one of:
the first RS comprises at least one of a CSI-RS, a synchronization signal and physical broadcast channel (PBCH) block (SSB), or a sounding reference signal (SRS);
each RS of the set of second RS comprises at least one of a SRS, a CSI-RS, or a SSB; or
each of the set of CSI comprises at least one one of reference signal received power (RSRP), reference signal received quality (RSRQ), a signal to interference plus noise ratio (SINR), a value quantifying the RSRP, a value quantifying the SINR, or a value quantifying the RSRQ.

4. The apparatus of claim 1, wherein each of the set of CSI comprises at least one of a measured value or a reserved value.

5. The apparatus of claim 1, wherein in if the set of second RS comprises more than one second RS, the set of CSI comprises a largest CSI among CSI based on a respective one of the set of second RS.

6. The apparatus of claim 1, wherein the CSI report further comprises at least one index associated with at least one second RS in the set of second RS.

7. The apparatus of claim 6, wherein each index of the at least one index associated with the at least one second RS comprises a Quasi-Co-Location (QCL) type D RS of the second RS or the second RS.

8. The apparatus of claim 6, wherein if the set of second RS includes more than one second RS, the set of CSI comprises an index associated with a second RS with a largest CSI among CSI based on a respective one of the set of second RS.

9. The apparatus of claim 3, wherein at least one of:
each CSI value of the set of CSI comprises an absolute value; or
when a first CSI value comprises an absolute value, each other CSI value of the set of CSI comprises a differential value relative to the first CSI value.

10. The apparatus of claim 1, wherein the processor is configured to cause the apparatus to:
receive a third RS on a third link with a third spatial domain receive filter or transmit the third RS on the third link with a third spatial domain transmit filter;
receive a set of fourth RS on a fourth link with a fourth spatial domain receive filter or transmit the set of fourth RS on the fourth link with a fourth spatial domain transmit filter; and
transmit the CSI report, wherein the CSI report further includes at least one of an index of the third RS and a PMI associated with the third RS, or another set of CSI at least based on the set of fourth RS.

11. The apparatus of claim 10, wherein one or more of the third spatial domain filter comprises a same configuration with the fourth spatial domain filter, or the third RS associated with the third spatial domain filter and the fourth RS associated with the fourth spatial domain filter are one or more of transmitted or received simultaneously.

12. The apparatus of claim 1, wherein each CSI of the set of CSI comprises at least one of:
a PMI based on a second RS of the second link, and at least one of rank indicator (RI) and channel quality indicator (CQI) based on second RS of the second link;
at least one of RI and CQI based on the second RS of the second link; or
at least one of RI and CQI based on both the first RS of the first link and the second RS of the second link.

13. The apparatus of claim 12, wherein the processor is configured to cause the apparatus to:
determine the PMI for the second link based on an indicated or predefined PMI set.

14. The apparatus of claim 1, wherein the CSI report is transmitted from an integrated access backhaul (IAB) mobile termination (MT) to an IAB distributed unit (DU) by physical uplink control channel (PUCCH) or physical uplink shared channel (PUSCH).

15. The apparatus of claim 1, wherein the CSI report is transmitted from an integrated access backhaul (IAB) distributed unit (DU) to another IAB DU via a F1 application protocol (F1-AP) signaling.

16. A method, comprising:
receiving a first reference signal (RS) on a first link with a first spatial domain receive filter or transmitting the first RS on the first link with a first spatial domain transmit filter;
receiving a set of second RS on a second link with a second spatial domain receive filter or transmitting the set of second RS on the second link with a second spatial domain transmit filter; and
transmitting a channel state information (CSI) report, the CSI report including:
at least one of an index of the first RS or a precoding matrix indicator (PMI) based on the first RS; and
a set of CSI at least based on the set of second RS.

17. The method of claim 16, wherein one or more of:
the first spatial domain receive filter has a same configuration with the second spatial domain receive filter;
the first spatial domain transmit filter has a same configuration with the second spatial domain transmit filter; or
the first RS associated with the first spatial domain filter and the second RS associated with the second spatial domain filter are one or more of transmitted or received simultaneously.

18. The method of claim 16, wherein if the CSI report comprises the index of the first RS, at least one of:
the first RS comprises at least one of a CSI-RS, a synchronization signal and physical broadcast channel (PBCH) block (SSB), or a sounding reference signal (SRS);
each of the set of second RS comprises at least one of a SRS, a CSI-RS, or a SSB; or
each of the set of CSI comprises at least one of reference signal received power (RSRP), reference signal received quality (RSRQ), a signal to interference plus noise ratio (SINR), a value quantifying the RSRP, a value quantifying the SINR, or a value quantifying the RSRQ.

19. The method of claim 16, wherein each CSI of the set of CSI comprises at least one of a measured value or a reserved value.

20. An apparatus, comprising:
a memory; and
a processor coupled to the memory, the processor configured to cause the apparatus to:
transmit, from a parent node to a child node, a first reference signal (RS) on a first link with a first spatial domain transmit filter or receive the first RS on the first link with a first spatial domain receive filter; and
receive, at the parent node and from the child node, a channel state information (CSI) report, the CSI report comprising at least one of an index of the first RS or a precoding matrix indicator (PMI) associated with the first RS.
